(19) United States
(12) Patent Application Publication
(10) Pub. No.: US 2015/0195575 A1
(43) Pub. Date: Jul. 9, 2015

(54) IMAGE ENCODING AND DECODING METHODS FOR PRESERVING FILM GRAIN NOISE, AND IMAGE ENCODING AND DECODING APPARATUSES FOR PRESERVING FILM GRAIN NOISE

(71) Applicants: SAMSUNG ELECTRONICS CO., LTD., Suwon-si (KR); INDUSTRY-ACADEMIC COOPERATION FOUNDATION, YONSEI UNIVERSITY, Seoul (KR)

(72) Inventors: Seung-soo JEONG, Seoul (KR); Sang-youn LEE, Seoul (KR); Seong-wan KIM, Suncheon-si (KR); Jae-ho LEE, Seoul (KR); Chan-yul KIM, Bucheon-si (KR); Ho-cheon WEY, Seongnam-si (KR)

(73) Assignees: SAMSUNG ELECTRONICS CO., LTD., Suwon-si (KR); INDUSTRY-ACADEMIC COOPERATION FOUNDATION, YONSEI UNIVERSITY, Seoul (KR)

(21) Appl. No.: 14/590,141

(22) Filed: Jan. 6, 2015

Related U.S. Application Data
(60) Provisional application No. 61/923,888, filed on Jan. 6, 2014.

(30) Foreign Application Priority Data
Oct. 16, 2014 (KR) 10-2013-0140167

(51) Int. Cl. H04N 19/67; H04N 19/154; H04N 19/17; H04N 19/124

(52) U.S. Cl. CPC H04N 19/67; H04N 19/124; H04N 19/154; H04N 19/17

(57) ABSTRACT

An image encoding method and an image decoding method, and an image encoder and an image decoder, are provided. The image encoding method includes detecting a static region and a motion region of an image, calculating an encoding error in the image, calculating a film grain noise (FGN) error in the motion region, and encoding the image to reduce an encoding error in the image other than the FGN error.

### CROSS-REFERENCE TO RELATED APPLICATION(S)

This application claims priority from U.S. Provisional Application No. 61/923,888, filed on Jan. 6, 2014, in the US Patent and Trademark Office, and Korean Patent Application No. 10-2014-0140167, filed on Oct. 16, 2014, in the Korean Intellectual Property Office, the disclosures of which are incorporated herein in their entireties by reference.

### BACKGROUND

1. Field

Apparatuses and methods consistent with exemplary embodiments relate to image encoding and decoding methods and apparatuses for preserving a film grain noise (FGN).

2. Description of Related Art

In some cases, an image producer inserts an artificial noise into image data in order to create special effects on a screen while reproducing movie contents developed on a film. For example, the image producer may insert an artificial noise such as a film grain noise (FGN) into the image data.

However, when the image data is encoded at a low bit rate by a high-efficiency image compression technology, a high-frequency FGN component may be recognized as noise and may be removed from encoded information. In this example, when a decoding apparatus restores an image based on the encoded information, the image may be restored with the FGN removed. As a result, the image may be restored differently from that of an original intention of the image producer.

Also, when an encoding apparatus encodes image data including consecutive frames using a high-efficiency image compression technology, because the image data is encoded by a hierarchical prediction technology, bit consumption may vary on a frame-by-frame basis, and thus, an included FGN may vary on a frame-by-frame basis. Accordingly, when frames encoded by high-efficiency image compression technology are restored and reproduced consecutively by the decoding apparatus, a flickering phenomenon in which the FGN appears and then disappears may occur on the screen. This flickering phenomenon may cause users to experience or perceive a poor image quality when viewing video or other imaging data.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments provide an image encoding and decoding methods and apparatuses for preserving a film grain noise (FGN) even in a case in which an image is encoded by a high-efficiency compression technology.

Additional aspects will be set forth in part in the description which follows and, in part, will be apparent from the description, or may be learned by practice of one or more of the exemplary embodiments.

### BRIEF DESCRIPTION OF THE DRAWINGS

The above and/or other aspects will be more apparent and more readily appreciated by describing certain exemplary embodiments with reference to the accompanying drawings, in which:

FIG. 1 is a block diagram of an image encoding apparatus for preserving a film grain noise (FGN), according to an exemplary embodiment;

FIG. 2 is a block diagram of an image decoding apparatus for preserving a FGN, according to an exemplary embodiment;

FIG. 3 is a block diagram of an image encoding apparatus for preserving a FGN, according to another exemplary embodiment;

FIG. 4 is a block diagram of an image decoding apparatus for preserving a FGN, according to another exemplary embodiment;

FIG. 5 is a flowchart of an image encoding method for preserving a FGN, according to an exemplary embodiment;

FIG. 6 is a flowchart of an image decoding method for preserving a FGN, according to an exemplary embodiment;

FIG. 7 is a flowchart of an image encoding method for preserving a FGN, according to another exemplary embodiment;

FIG. 8 is a flowchart of an image decoding method for preserving a FGN, according to another exemplary embodiment;

FIG. 9 is a diagram illustrating a process of encoding a plurality of current frames using a structural similarity (SSIM) of a plurality of encoded frames by an image encoding apparatus, according to an exemplary embodiment;

FIG. 10 is a diagram illustrating encoding and decoding a current image by an image encoding apparatus and an image decoding apparatus, according to an exemplary embodiment; and

FIG. 11 is a diagram illustrating encoding and decoding a current image by an image encoding apparatus and an image decoding apparatus, according to another exemplary embodiment.

### DETAILED DESCRIPTION

The exemplary embodiments are described herein in greater detail with reference to the accompanying drawings. Throughout the drawings and the detailed description, unless otherwise provided or described, like reference numerals should be understood to refer to like elements, features, and structures. In this regard, one or more of the exemplary embodiments may have different forms and should not be construed as being limited to the descriptions set forth herein. Accordingly, the exemplary embodiments are merely described below, by referring to the figures, to explain aspects of the present description.

In various exemplary embodiments described herein, “images” may generally refer to not only still images but also moving images such as videos.

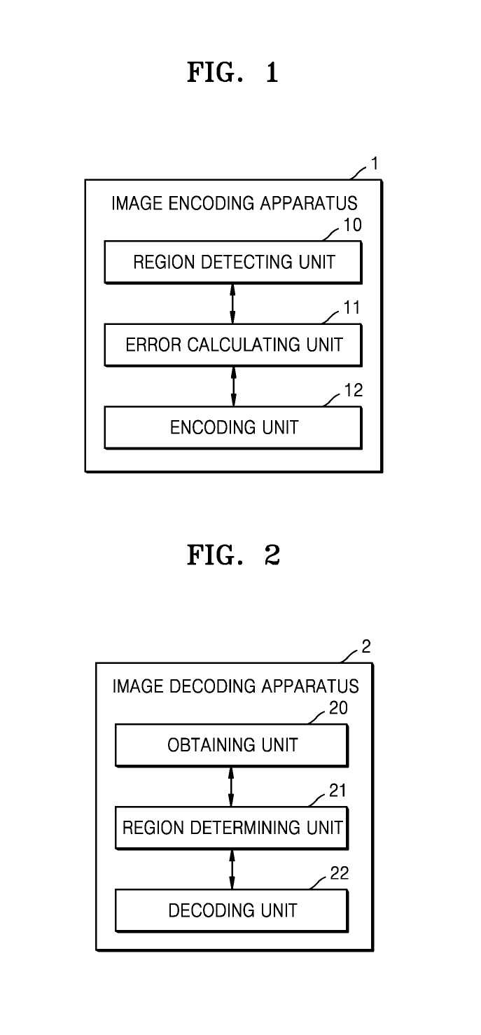

Hereinafter, image encoding and decoding methods for preserving a film grain noise (FGN) and image encoding and decoding apparatuses for performing the image encoding and decoding methods according to various exemplary embodiments are described with reference to FIGS. 1 to 11.

As used herein, the singular forms “a,” “an” and “the” are intended to include the plural forms as well, unless the context clearly indicates otherwise.

In the following description, because the same reference numerals may denote the same elements or corresponding elements, redundant descriptions thereof may be omitted for easier reading.

FIG. 1 is a block diagram of an image encoding apparatus 1 for preserving a FGN, according to an exemplary embodiment.

Referring to FIG. 1, the image encoding apparatus 1 includes a region detecting unit 10, an error calculating unit 11, and an encoding unit 12.

Referring to FIG. 1, the region detecting unit 10 may detect a static region of and a motion region of an image such as a current image. Herein, the static region may refer to a region that does not have a significant information difference between pixels in the region, and the motion region may refer to a region that has a significant information difference between pixels in the region. In other words, the static region may correspond to a region where motion may not exist, and the motion region may correspond to a region where motion does exist.

For example, the static region may refer to a region that has a small information difference between a region of the current image among consecutive images and a region of the previous image located at the same position as the region of the current image, and the motion region may refer to a region that has a significant information difference between a region of the current image and a region of the previous image located at the same position as the region of the current image. The small information difference and the significant information difference may be determined based on respective thresholds for information difference. For example, a small information difference may be an information difference that is below a predetermined threshold whereas a significant information difference may be an information difference that is above the predetermined threshold, or above another threshold.

As a non-limiting example, a region including image data representing a sky portion has almost no pixel value difference between pixels in the region. Accordingly, the region detecting unit 10 may detect the region including the sky portion as the static region. Also, a region including image data representing a sky portion has a small pixel value difference between a region of the current image and a region of the previous image located at the same position as the region of the current image. Accordingly, the region detecting unit 10 may detect the region including the sky portion as the static region.

On the other hand, a region including image data representing a boundary portion of an object may have a significant pixel value difference between pixels at the boundary portion of the object in the region. Accordingly, the region detecting unit 10 may detect the region including the boundary portion of the object as the motion region.

Also, if a region including image data representing an object has a significant pixel value difference between a region of the current image and a region of the previous image located at the same position as the region of the current image, the region detecting unit 10 may detect the region including the object as the motion region.

The region detecting unit 10 may generate an image in which a FGN is removed from the current image and detect the motion region in the generated image. For example, the region detecting unit 10 may use a non-linear filter such as a median filter to remove the FGN. As another example, the region detecting unit 10 may detect the motion region of the current image by morphological processing. The morphological processing may include, for example, erosion and dilation processing.

The error calculating unit 11 may calculate an encoding error in the current image and calculate a FGN error in the motion region detected by the region detecting unit 10. For example, the error calculating unit 11 may determine a distortion value of a rate-distortion (RD) cost in consideration of not only a FGN distortion but also a quantization distortion. The error calculating unit 11 may calculate a FGN error in the motion region in consideration of a quantization error.

For example, the error calculating unit 11 may determine a FGN distortion value by Equation (1) below.

$${D}_{FGN} = {\sum }_{( i , j ) ∈ {R}_{static}} {d ( i , j )}^{2} + α * {\sum }_{( i , j ) ∈ {R}_{motion}} {d ( i , j )}^{2} \qquad [ Equation ( 1 ) ]$$

In the example of Equation (1), “D_{FGN}” denotes the FGN distortion value of the current image, “i,j” denotes positions on x and y coordinates of a pixel in the current image, respectively, “d(i,j)” denotes a FGN distortion value of a pixel located at a position represented by i,j, “R_{static}” denotes the static region of the current image, and “Rₘₒₜᵢₒₙ” denotes the motion region of the current image. Also, “a” denotes a weight parameter for consideration of a quantization distortion.

The error calculating unit 11 may calculate a FGN error in the motion region by calculating a FGN error of a chroma component and a FGN error of a luminance (i.e. luma) component in the current image. As an example, the error calculating unit 11 may calculate a total FGN error in consideration of a quantization parameter difference between the chroma component and the luma component of the image.

For example, the error calculating unit 11 may calculate the FGN distortion value by Equation (2) below.

D_{FGN}=D_{FGN}_{_{—}}_{Y}+W_{chroma}*(D_{FGN}_{_{Cb}}+D_{FGN}_{_{Cr}}) [Equation (2)]

In the example of Equation (2), “D_{FGN}” denotes the FGN distortion value of the current image, “D_{FGN}_{_{—}}_{Y}” denotes the FGN distortion value of the luma component of the current image, “D_{FGN}_{_{—}}_{Cb}, D_{FGN}_{_{—}}_{Cr}” denotes the FGN distortion value of the chroma component, Cb, and Cr of the current image, and “w_{chroma}” denotes a weight parameter based on the quantization parameter difference between the chroma component and the luma component of the current image.

The encoding unit 12 may encode the current image so as to minimize or otherwise reduce an error equal to the encoding error in the current image minus the FGN error. For example, the encoding unit 12 may encode the current image by various encoding methods and may calculate a rate-distortion (RD) cost in this case to determine to an optimal RD cost. The encoding unit 12 may encode the current image by an encoding method based on an optimal determined RD cost.

For example, the encoding unit 12 may calculate a distortion value exclusive of a FGN distortion by Equation (3) below. In the example of Equation (3), “D_{FGNO}” denotes the distortion value exclusive of the FGN distortion.

D_{FGNO}=D_{RDO}−D_{FGN} [Equation (3)]

In this example, “D_{RDO}” denotes an image distortion value that is calculated without exception of the FGN distortion, and “D_{FGN}” denotes the FGN distortion value.

The image encoding apparatus 1 may further include an image quality distribution structure determining unit (not illustrated). The image quality distribution structure determining unit may analyze a parameter that is used to encode a plurality of frames including the current image. The image quality distribution structure determining unit may determine an image quality difference caused by different values of the parameter that is used to encode the plurality of frames, and may determine an image quality distribution structure of a plurality of frames representing the determined image quality difference.

The image quality distribution structure determining unit may also determine an image quality distribution structure of frames that are to be encoded on the basis of the determined image quality distribution structure of the plurality of frames.

The encoding unit 12 may determine a parameter of the frames to be encoded on the basis of the image quality distribution structure of the current frames which are determined based on the image quality distribution structure of the previously encoded frames. Thus, the encoding unit 12 may encode the current frames on the basis of the determined parameter.

In this regard, the FGN of the current frame may vary according to the image quality distribution structure of the current frame. That is, an encoding parameter may be determined according to the image quality distribution structure of the current frames, and bit consumption in a current image may be determined according to the determined encoding parameter. For example, when bit consumption in the current frames is large, because the current frames inclusive of the FGN are compressively encoded, the FGN of the current frames may increase.

FIG. 2 is a block diagram of an image decoding apparatus 2 for preserving a FGN, according to an exemplary embodiment.

Referring to FIG. 2, the image decoding apparatus 2 includes an obtaining unit 20, a region determining unit 21, and a decoding unit 22.

The obtaining unit 20 may obtain encoded information from a bitstream. In this example, an error in the current image may be calculated, a FGN error in the motion region may be calculated, and the encoded information may be generated by encoding the current image so as to minimize or otherwise reduce an error that is equal to the error in the current image minus the FGN error.

Also, the image encoding apparatus 1 may calculate a FGN error in the motion region in consideration of a quantization error. The encoded information may include information that is generated by encoding the current image on the basis of the calculated FGN error so as to minimize or otherwise reduce an error equal to the encoding error in the current image minus the FGN error.

Also, the image encoding apparatus 1 may calculate a FGN error of a chroma component and a FGN error of a luma component in the current image, and the encoded information may include information that is generated by encoding the current image on the basis of the calculated FGN errors so as to minimize an error equal to the encoding error in the current image minus the FGN error. As another example, the image encoding apparatus 1 may calculate a total FGN error of the chroma and luma components of the current image in consideration of a quantization parameter difference between the chroma component and the luma component of the current image, and the encoded information may include information that is generated by encoding the current image on the basis of the calculated total FGN error so as to minimize an error equal to the encoding error in the current image minus the FGN error.

The image decoding apparatus 2 may restore the current image on the basis of the error of the current image that is exclusive of the FGN error by performing decoding using the encoded information obtained by the obtaining unit 20.

According to various aspects of one or more exemplary embodiments, the region determining unit 21 may determine a static region and a motion region of the current image. For example, the region determining unit 21 may determine the static region and the motion region of the current image on the basis of the obtained encoded information.

The decoding unit 22 may restore the current image in consideration of the FGN. In this regard, the decoding unit 22 may restore the current image in consideration of the FGN based on the encoded information that is obtained by the obtaining unit 20.

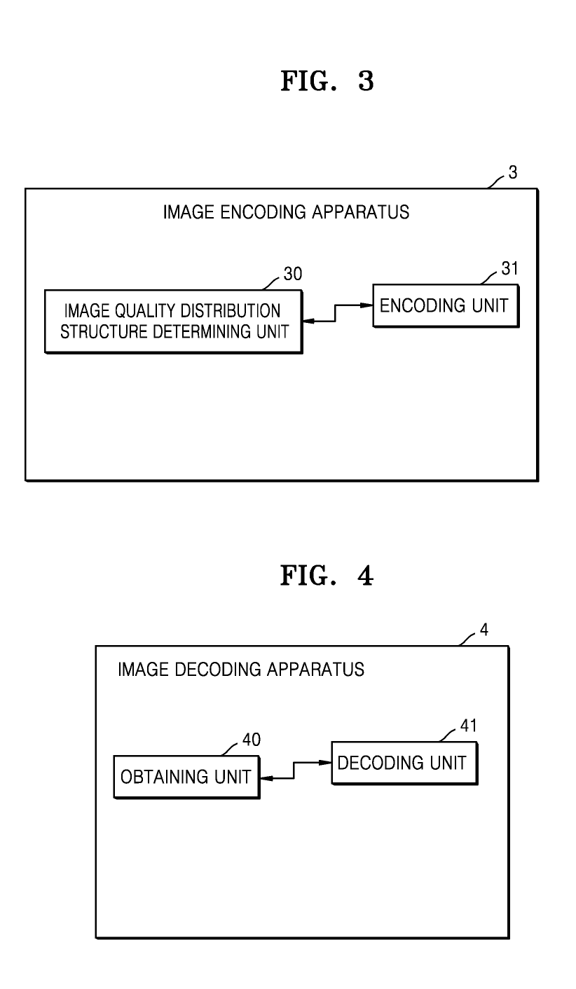

FIG. 3 is a block diagram of an image encoding apparatus 3 for preserving a FGN, according to another exemplary embodiment.

Referring to FIG. 3, in this example the image encoding apparatus 3 includes an image quality distribution structure determining unit 30 and an encoding unit 31.

The image quality distribution structure determining unit 30 may analyze a parameter used to encode a plurality of previous frames. In this example, the image quality distribution structure determining unit 30 may determine an image quality difference caused by different values of the analyzed parameter. Accordingly, the image quality distribution structure determining unit 30 may determine an image quality distribution structure of previous frames representing the determined image quality difference.

For example, the image quality distribution structure determining unit 30 may determine the image quality distribution structure of the previous frames representing the determined image quality difference using a frame image quality evaluation index of encoded previous frames. As an example, the frame image quality evaluation index may be a structural similarity (SSIM) value. However, exemplary embodiments are not limited thereto, and in various examples the frame image quality evaluation index may be a peak signal-to-noise ratio (PSNR) value, a mean squared error (MSE) value, a novel feature-similarity (FSIM) value, and the like. The SSIM value may be a measurement value of the similarity between images. The SSIM value may be determined by Equation (4) below.

SSIM(x,y)=l(x,y)·c(x,y)·s(x,y) [Equation (4)]

In the example of Equation (4), “x,y” denotes blocks of different images, “l(x,y)” denotes a luminance index of an x,y block, “c(x,y)” denotes a contrast index of the x,y block, and “S(x,y)” denotes a structural correlation index of the x,y block. The respective indexes are described below.

The luminance index “l(x,y)” may be calculated by calculating a mean of pixel values in two image blocks and using a harmonic mean of a ratio between two values and a reciprocal thereof. That is, “l(x,y)” may be determined by Equation (5) below.

$$l ( x , y ) = \frac{2 {μ}_{x} {μ}_{y}}{{μ}_{x}^{2} + {μ}_{y}^{2}} \qquad [ Equation ( 5 ) ]$$

In the example of Equation 5, “μₓ” denotes a mean of pixel values in the x block, “μ_{y}” denotes a mean of pixel values in the y block, and “l(x,y)” denotes a brightness difference between two images. When two images have different brightness values due to a brightness difference, “l(x,y)” may approach “0”, and when two images have similar brightness values, “l(x,y)” may approach “1”.

The contrast index “c(x,y)” may be determined by a standard deviation of blocks in two images, and “c(x,y)” may be determined by Equation (6) below.

$$c ( x , y ) = \frac{2 {σ}_{x} {σ}_{y}}{{σ}_{x}^{2} + {σ}_{y}^{2}} \qquad [ Equation ( 6 ) ]$$

In the example of Equation (6), “σₓ” denotes a standard deviation of pixel values in the x block, and “σ_{y}” denotes a standard deviation of pixel values in the y block. Also, “c(x,y)” represents a distribution range of pixel values in two image pixels, and “c(x,y)” may have a range of [0,1]. When “c(x,y)” is great, it may denote that the two images are similar to each other.

The structural correlation index “s(x,y)” may use the covariance of two images. As an example, “s(x,y)” may be determined by Equation (7) below.

$$s ( x , y ) = \frac{{σ}_{xy}}{{σ}_{x} {σ}_{y}} \qquad [ Equation ( 7 ) ]$$

In Equation (7), “σₓ” denotes a standard deviation of pixel values in the x block, “σ_{y}” denotes a standard deviation of pixel values in the y block, and “σ_{xy}” denotes the covariance of the pixel values in the x block and the pixel values in the y block.

Equations (4), (5), (6), and (7) may be summarized as Equation (8) below.

$$S S I M ( x , y ) = \frac{2 {μ}_{x} {μ}_{y} + {C}_{1}}{{μ}_{x}^{2} + {μ}_{y}^{2} + {C}_{1}} \frac{2 {σ}_{xy} + {C}_{2}}{{σ}_{x}^{2} + {σ}_{y}^{2} + {C}_{2}} \qquad [ Equation ( 8 ) ]$$

In the example of Equation (8), C₁ and C₂ denote regularization terms for solving a problem caused when a denominator is small. A SSIM(x,y) value may be an index that is used for comparison of image quality between images. For example, when the SSIM value is great, or above a threshold value, it may denote that the image quality difference between images is not significant, and thus users may feel that the image quality is good. When the SSIM value is small, it may denote that the image quality difference between images is significant, or otherwise below a threshold value, and thus users may feel that the image quality is poor.

For example, when the SSIM value of the previous frame 1 is about 0.70 and the SSIM value of the previous frame 2 is about 0.75, the SSIM value difference between the previous frames 1 and 2 is about 0.05. In this example, the image quality distribution structure determining unit 30 may determine an image quality distribution structure representing that the SSIM value difference between the frames as about 0.05. That is, when there is an SSIM value difference between the previous frames 1 and 2, an image quality difference may occur between the previous frames 1 and 2, and thus, an image quality distribution structure representing an image quality difference between the frames may be determined.

For example, the image quality distribution structure determining unit 30 may determine an image quality distribution structure of previous frames by analyzing an image quality difference between the previous frame representing the maximum SSIM value in the previous group of pictures (GOP) and the previous frame representing the minimum SSIM value.

The image quality distribution structure determining unit 30 may determine an image quality distribution structure of current frames based on the determined image quality distribution structure of the previous frames. For example, the image quality distribution structure determining unit 30 may determine an image quality distribution structure of the current frames when a SSIM value difference between the frame representing the maximum SSIM value among the previous frames encoded and the frame representing the minimum SSIM value is greater than a predetermined value. As an example, the predetermined value may be preset by a user through a user interface. For example, the predetermined value may be set by an administrator in the process of manufacturing the image encoding apparatus 3.

The image quality distribution structure determining unit 30 may adjust the SSIM value of the current frame corresponding to the previous frame causing an image quality reduction from among the previous frames encoded before the current frame. For example, if the frame representing the minimum SSIM value is smaller than a predetermined value, the image quality distribution structure determining unit 30 may determine the previous frame representing the minimum SSIM value as the previous frame causing an image quality reduction.

The image quality distribution structure determining unit 30 may set a target image quality of the current frame using Equation (9) below. For example, equation (9) may be summarized as Equation (10) below.

[Max_{—}SSIM−Cur_{—}SSIM]/[Max_{—}SSIM−Min_{—}SSIM]=[Max_{—}SSIM−Tar_{—}SSIM]/Setting_{—}V [Equation (9)]

Tar_{—}SSIM=Max_{—}SSIM−Setting_{—}V*[Max_{—}SSIM−Cur_{—}SSIM]/[Max_{—}SSIM−Min_{—}SSIM] [Equation (10)]

In the examples of Equations (9) and (10), Max_SSIM denotes the SSIM value of the frame having the greatest SSIM value in the previous GOP, Min_SSIM denotes the SSIM value of the frame having the smallest SSIM value in the previous GOP, and Cur_SSIM denotes the SSIM value of the frame in the previous GOP corresponding to the current frame that is to be encoded. Tar_SSIM denotes the SSIM value of the frame that is to be encoded. Setting_V denotes a value determined by user input or image analysis.

For example, when the Max_SSIM value is about 10, the Cur_SSIM value is about 5, the Min_SSIM value is about 0, and the Setting_V value is about 5, the Tar_SSIM value may be determined as about 7.5.

The encoding unit 31 may determine an encoding parameter of the current frames on the basis of the image quality distribution structure of the current frames determined by the image quality distribution structure determining unit 30.

For example, the encoding unit 31 may determine a Lagrange multiplier of the frame to be encoded, by using a Lagrange multiplier, the SSIM value of the previous frames encoded before the current frames, and the SSIM value of the current frame determined by the image quality distribution structure determining unit 30. The encoding unit 31 may encode the current frames based on the determined encoding parameter. For example, the encoding unit 31 may encode the current frames according to the determined Lagrange multiplier.

As a non-limiting example, the encoding unit 31 may determine an encoding parameter lambda of the current frame to be encoded, by using Equation (11) below. Equation (11) may be summarized as Equation (12) below.

Tar_{—}SSIM:1/Tlambda=Max_{—}SSIM:1/Min_lambda [Equation (11)]

Tlambda=Max_SSIM*Min_lambda/Tar_{—}SSIM [Equation (12)]

In the example of Equations (11) and (12), Tar_SSIM denotes the SSIM value of the current frame in Equation (9) or (10), and Tlambda denotes a lambda value for the SSIM value of the current frame. Herein, the lambda value may refer to a Lagrange multiplier. Max_SSIM denotes the SSIM value of the frame representing the greatest SSIM value in the previous GOP, and Min_lambda denotes the lambda value of the frame representing the greatest SSIM value in the previous GOP. For example, when Tar_SSIM is about 7.5, Min_lambda is about 10, Max_SSIM is about 15, and Tlambda may be about 20.

The image quality distribution structure determining unit 30 and the encoding unit 31 of the image encoding apparatus 3 illustrated in FIG. 3 may correspond to the image quality distribution structure determining unit (not illustrated) and the encoding unit 12 of the image encoding apparatus 1 illustrated in FIG. 1, respectively. Thus, the description of the image quality distribution structure determining unit 30 and the encoding unit 31 of FIG. 3 may be added here in relation to the image quality distribution structure determining unit (not illustrated) and the encoding unit 12 of FIG. 1.

FIG. 4 is a block diagram of an image decoding apparatus 4 for preserving a FGN, according to another exemplary embodiment.

Referring to FIG. 4, the image decoding apparatus 4 includes an obtaining unit 40 and a decoding unit 41.

The obtaining unit 40 may obtain encoded information from a bitstream. For example, the image encoding apparatus 3 may determine an image quality distribution structure of the previous frames representing an image quality difference caused by different values of a parameter used to encode the previous frames, determine an image quality distribution structure of the current frames based on the determined image quality distribution structure of the previous frames, and determine an encoding parameter of the current frames based on the determined image quality distribution structure of the current frames. The encoded information may be generated by encoding the current frames based on the determined encoding parameter.

The image decoding apparatus 4 may determine an encoding parameter of the frames generated using the encoded information obtained by the obtaining unit 40 and perform decoding using the determined encoding parameter, to restore the current frames.

The decoding unit 41 may restore the current frames by using the encoded information obtained by the obtaining unit 40. For example, the decoding unit 41 may restore the current frames on the basis of the encoding parameter of the current frames included in the encoded information.

The obtaining unit 40 and the decoding unit 41 of the image decoding unit 4 illustrated in FIG. 4 may correspond to the obtaining unit 20 and the decoding unit 22 of the image decoding unit 2 illustrated in FIG. 2, respectively. Thus, the description of the obtaining unit 40 and the decoding unit 41 of FIG. 4 may be added to the obtaining unit 20 and the decoding unit 22 of FIG. 2, respectively.

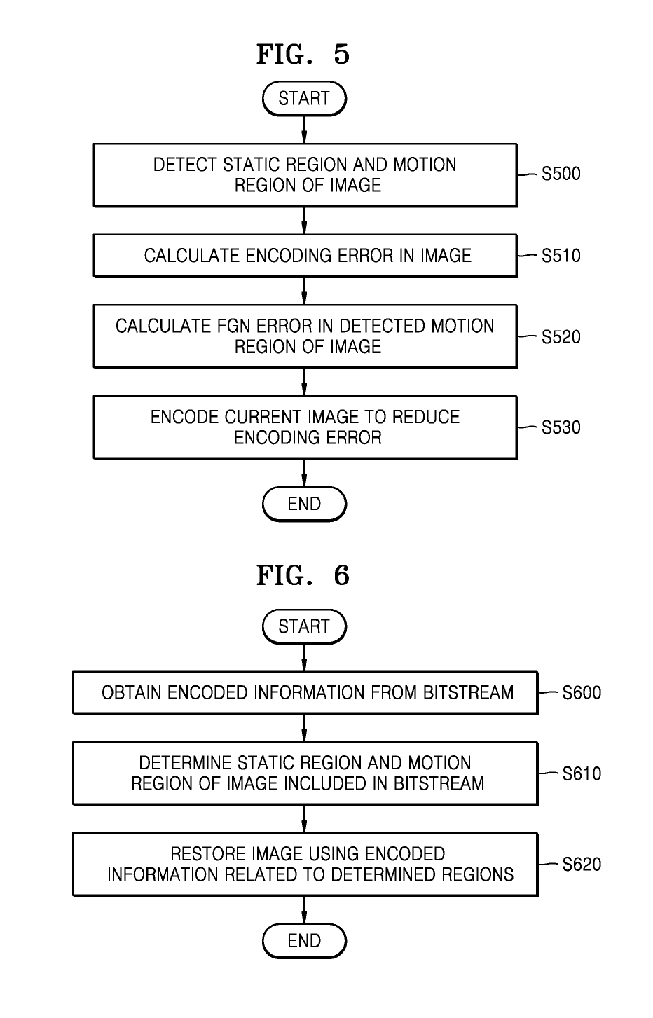

FIG. 5 is a flowchart of an image encoding method for preserving a FGN, according to an exemplary embodiment.

Referring to FIG. 5, in operation S500, the image encoding apparatus 1 detects a static region and a motion region of an image.

In operation S510, the image encoding apparatus 1 calculates an encoding error in the image.

In operation S520, the image encoding apparatus 1 calculates a FGN error in the detected motion region of the image.

In operation S530, the image encoding unit 1 encodes the image to reduce the encoding error. Or the image encoding unit 1 encodes the image to minimize the encoding error. The encoding error to be reduced or to be minimized may be the encoding error in the image other than the calculated error. For example, The encoding error to be reduced or to be minimized may be the encoding error in the current image excluding the FGN error. That is, The encoding error to be reduced or to be minimized may be the encoding error equal to the error in the current image minus the FGN error.

FIG. 6 is a flowchart of an image decoding method for preserving a FGN, according to an exemplary embodiment.

Referring to FIG. 6, in operation S600, the image decoding apparatus 2 obtains encoded information from a bitstream. For example, an error in the current image may be calculated, and the encoded information may be generated by encoding the current image to minimize or otherwise an error. The error to be minimized is the error in the current image excluding the FGN error.

In operation S610, the image decoding apparatus 2 determines a static region and a motion region of an image included in the bitstream. For example, the image decoding apparatus 2 may determine the static region and the motion region of the image based on information about the static region and the motion region of the current image, included in the encoded information.

In operation S620, the image decoding apparatus 2 restores the image using encoded information related to the determined regions. The image decoding apparatus 2 may restore the current image using the encoded information about the static region and the motion region of the current image.

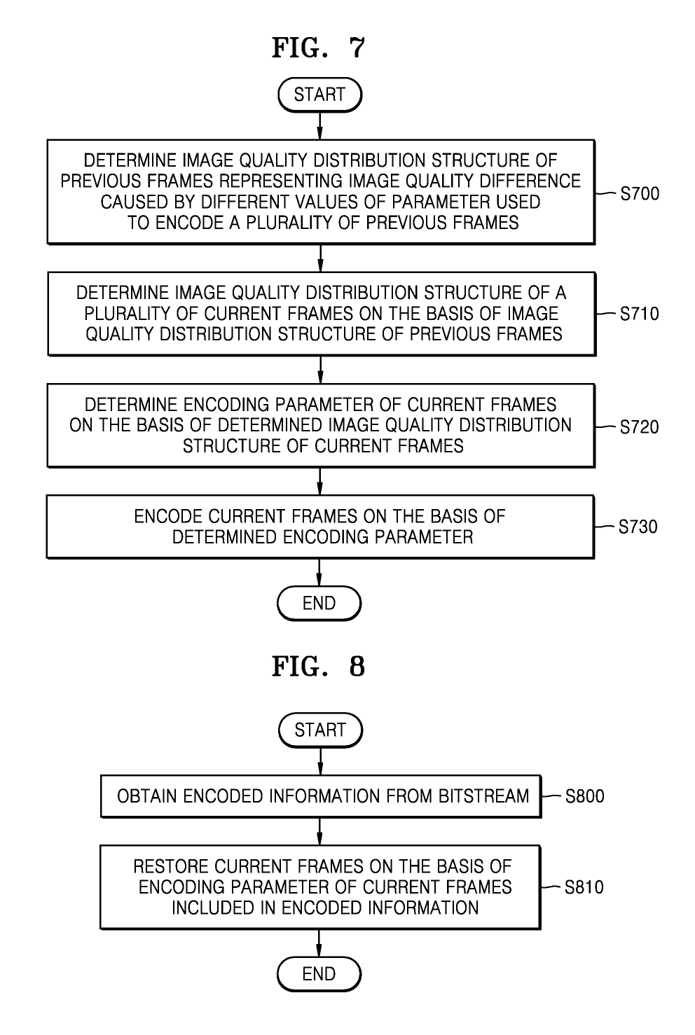

FIG. 7 is a flowchart of an image encoding method for preserving a FGN, according to another exemplary embodiment.

Referring to FIG. 7, in operation S700, the image encoding apparatus 3 determines an image quality distribution structure of previous frames representing an image quality difference caused by different values of a parameter used to encode a plurality of previous frames.

In operation S710, the image encoding apparatus 3 determines an image quality distribution structure of a plurality of current frames on the basis of the image quality distribution structure of the previous frames.

In operation S720, the image encoding apparatus 3 determines an encoding parameter of the current frames on the basis of the determined image quality distribution structure of the current frames.

In operation S730, the image encoding apparatus 3 encodes the current frames on the basis of the determined encoding parameter.

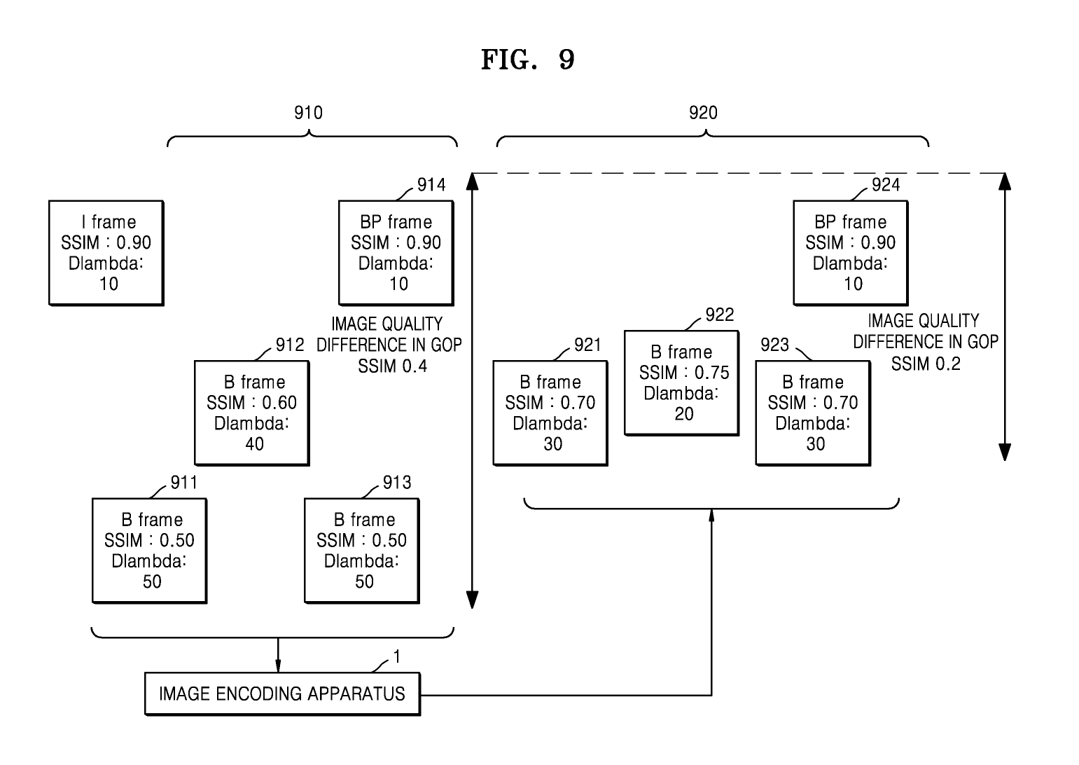

FIG. 8 is a flowchart of an image decoding method for preserving a FGN, according to another exemplary embodiment.

Referring to FIG. 8, in operation S800, the image decoding apparatus 4 obtains encoded information from a bitstream. For example, the image encoding apparatus 3 may determine an image quality distribution structure of previous frames that represent an image quality difference caused by different values of a parameter that is used to encode a plurality of previous frames. Accordingly, the image encoding apparatus 3 may determine an image quality distribution structure of a plurality of current frames on the basis of the determined image quality distribution structure of the previous frames, and determine an encoding parameter of the current frames on the basis of the determined image quality distribution structure of the current frames. For example, the encoded information may include information that is generated by encoding the current frames on the basis of the determined encoding parameter.

In operation S810, the image decoding apparatus 4 restores the current frames on the basis of the encoding a parameter of the current frames included in the encoded information.

FIG. 9 is a diagram illustrating a process of encoding a plurality of current frames using a SSIM of a plurality of encoded frames, by an image encoding apparatus, according to an exemplary embodiment. For example, the image encoding apparatus shown in FIGS. 1 and 3 may calculate a SSIM value and a lambda value of each frame in an encoding process.

Referring to FIG. 9, frames 910 are frames that are previously encoded. A SSIM value and a lambda value may be calculated in the process of encoding each of the frames 910. In this example, frame 911 is a B frame and has a SSIM value of about 0.50 and a lambda value of about 50, frame 912 is a B frame and has a SSIM value of about 0.60 and a lambda value of about 50, frame 913 is a B frame and has a SSIM value of about 0.60 and a lambda value of about 50, and frame 914 is a BP frame and has a SSIM value of about 0.90 and a lambda value of about 10. In this example, an image quality distribution structure between the frames 910 may represent an inter-frame image quality difference represented in proportion to the SSIM value or in inverse proportion to the lambda value.

For example, referring to FIG. 9, the image quality distribution structure between the frames 910 may have a shape of “/V”. The /V-shaped image quality distribution structure may be generated by encoding a frame referred to many frames at a high bit rate by applying a low quantization parameter because it greatly affects other frames, and by encoding a frame referred to a few frames at a low bit rate by applying a high quantization parameter. This example may increase encoding efficiency by encoding the frames by a hierarchical prediction that varies an image quality of each frame in one GOP. For the encoding efficiency, the shape of the image quality distribution structure in the GOP may be similar in different GOPs.

Frames 920 are current frames that are to be encoded. In this example, the difference between the maximum SSIM value and the minimum SSIM value of the frames 910 is about 0.4. With respect to this SSIM value difference, it is assumed that the image encoding apparatus 1 determines that an inter-frame image quality difference in this example is significant. For example, the inter-frame image quality difference may be above a predetermined threshold.

In this example, the frame 914 has a high SSIM value of about 0.90 and is encoded using a low quantization parameter. Because the frame 914 is encoded using a relatively low quantization parameter, the frame 914 is encoded at a high bit rate. That is, according to various exemplary embodiments, because the frame 914 is encoded without filtering a FGN that is a high-frequency component, the frame 914 includes a FGN that is not filtered.

The frame 913 has a SSIM value of about 0.50 and is encoded using a high quantization parameter. That is, the frame 913 may be encoded using a relatively high quantization parameter. Because the frame 913 is encoded using a high quantization parameter, the frame 913 may be encoded at a low bit rate. For example, because the frame 913 may be encoded while filtering a FGN that is a high-frequency component, the frame 913 may include a FGN that is filtered.

Thus, when the frames are decoded, the decoded frame 913 includes a FGN that is filtered, and the decoded frame 914 includes a FGN that is not filtered. In this example, when the decoded frames 913 and 914 are consecutively reproduced by the image decoding apparatus 2, a flickering phenomenon in which a FGN appears and then disappears may occur on a reproduced screen. That is, according to various aspects, the flickering phenomenon caused by a FGN in encoded image data or video data may be reduced.

The image encoding apparatus 1 determines an image quality distribution structure of the current frames to be encoded, on the basis of the image quality distribution structure of the frames that are previously encoded. For example, referring to FIG. 9, a difference between frame 914 representing the maximum SSIM among the previous frames 910 and frames 911 and 913 representing the minimum SSIM is about 0.4. The image encoding apparatus 1 may adjust the SSIM value of the current frames 920 to be encoded such that a difference between a frame 924 representing the maximum SSIM among the frames to be encoded and frames 921 and 923 representing the minimum SSIM is approximately 0.2 which is the half of 0.4. For example, a SSIM difference between the frame 911 and the frame 914 is about 0.4, and the image encoding apparatus 1 may determine SSIM values of the frame 921 and the frame 924 so that a SSIM difference between the frame 921 and the frame 924 is about 0.2. When the frame 924 representing the maximum SSIM value is maintained at about 0.9, which is equal to the SSIM value of the previously-encoded previous frame 914 corresponding to the frame 924, the image encoding apparatus 1 may adjust the frames 921 and 923 to have a SSIM value of about 0.7.

In this example, a SSIM difference between the frame 912 and the frame 914 is about 0.3. Here, the image encoding apparatus 1 may adjust the SSIM value of the current frame 922 to be encoded, so that a SSIM difference between the frame 922 and the frame 924 is about 0.15 which is about half of 0.3. That is, when the frame 924 is maintained at about 0.9 that is equal to the SSIM value of the previous frame 914 corresponding to the frame 924, the image encoding apparatus 1 may adjust the SSIM value of the frame 922 to about 0.75.

When the SSIM values of the frames 920 to be encoded are determined, the image encoding apparatus 1 may determine lambda values on the basis of the determined SSIM values. For example, the image encoding apparatus 1 may determine lambda values of the frames 920 to be encoded based on the lambda values and the SSIM values of the previously-encoded frames and the determined SSIM values of the frames 920 using the fact that there is an inverse proportional relationship between the SSIM value and the lambda value. For example, if the determined SSIM value of the frame 921 is about 0.7, the image encoding apparatus 1 may determine the lambda value of the frame 921 as about 30.

However, one or more exemplary embodiments are not limited thereto, and the image encoding apparatus 1 may preset a target image quality coefficient of each frame of the current frames to be encoded and may determine an image quality coefficient of the current frame so that the image quality coefficient of the current frame reaches the target image quality coefficient of each frame of the current frames, in response to the image quality coefficient of the encoded previous frame in the previous GOP corresponding to the current frame being low. However, even in this example, the image quality distribution structure shape of the previous frames may be maintained. For example, in the case where the SSIM value of the previously-encoded previous frame 1 is about 0.5 and the SSIM value of the previous frame 2 is about 0.6, if the image encoding apparatus 1 has determined the SSIM value of the current frame 2 corresponding to the previous frame 2 as about 0.8, the image encoding apparatus 1 may determine the SSIM value of the current frame 1 corresponding to the previous frame 1 as less than about 0.8 based on the image quality distribution structure in which the SSIM value of the previous frame 1 does not exceed the SSIM value of the previous frame 2 even when the target SSIM value of the frame 1 corresponding to the previous frame 1 is set to about 0.85.

As an example, the image encoding apparatus 1 may reduce a change gap of the SSIM value between frames in a GOP by adjusting the SSIM values of the frames 920 so that a difference between the frame 924 representing the maximum SSIM value among the current frames 920 to be encoded and the frame 921 representing the minimum SSIM value, is about 0.2.

However, as another example the image quality distribution structure shape of the current frames 920 represented by the inter-frame SSIM value difference may be the image quality distribution structure shape of the previous frames 910. For example, viewers may expect an overall image quality improvement because the change gap of the SSIM value between the frames to be encoded is reduced while maintaining the structure of hierarchical prediction in the standard codec for encoding.

Accordingly, the image encoding apparatus 1 may use a lower quantization parameter and a higher bit rate to encode the frames 920 than to encode the frames 910. Accordingly, because the FGN is a high-frequency signal that may be less filtered, the problem related to a subjective image quality degradation, such as a flickering phenomenon that occurs when a viewer views images, may be resolved or otherwise compensated for.

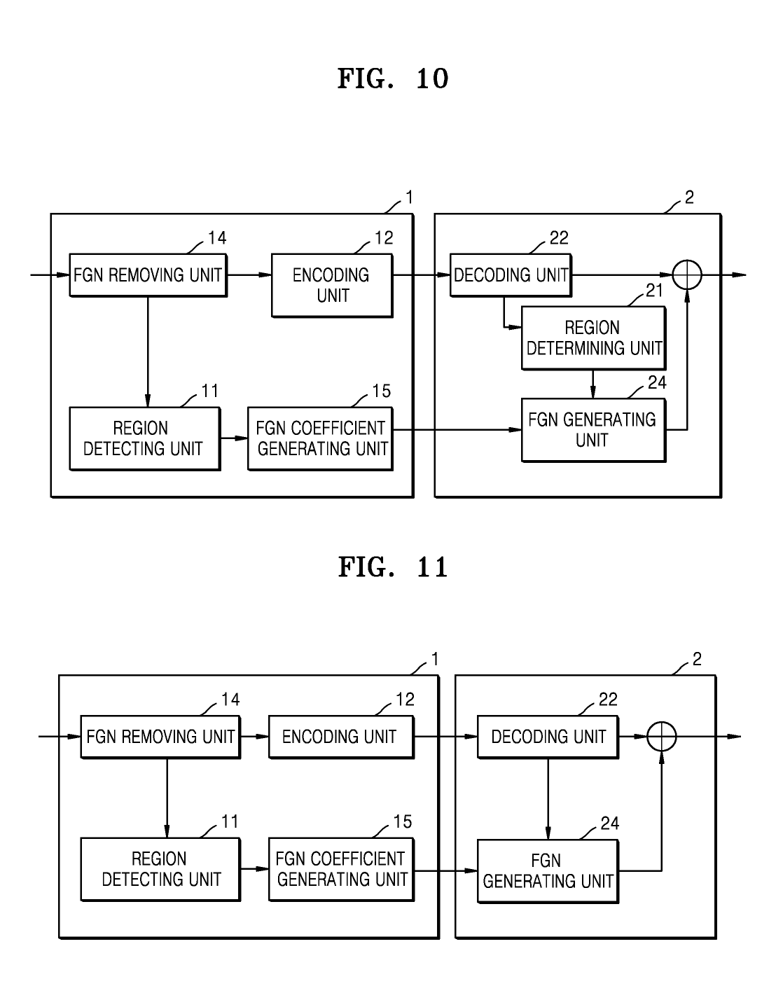

FIG. 10 is a diagram illustrating encoding and decoding a current image by an image encoding apparatus 1 and an image decoding apparatus 2, according to an exemplary embodiment.

Referring to FIG. 10, the image encoding apparatus 1 includes a region detecting unit 11, an encoding unit 12, a FGN removing unit 14, and a FGN coefficient generating unit 15.

Based on a current image, the FGN removing unit 14 may generate a current image exclusive of a FGN and a current image including a FGN. In this example, the region detecting unit 11 may detect a motion region of the current image from the current image including the FGN. The FGN coefficient generating unit 15 may generate FGN coefficients differently based on the motion region detected by the region detecting unit 11. The FGN coefficient generating unit 15 may determine a FGN coefficient of an image including a FGN of a motionless region in the same way as that of the conventional FGN coefficient determining method, and may generate a FGN coefficient of a motion region in consideration of not only a FGN but also a quantization parameter. The encoding unit 12 may encode the current image from which the FGN is removed by the FGN removing unit 14. For example, information about the FGN coefficient generated by the FGN coefficient generating unit 15 may be transmitted to the image decoding apparatus 2 together with information encoded by the encoding unit 12.

The image decoding apparatus 2 of FIG. 10 includes a region determining unit 21, a decoding unit 22, and a FGN generating unit 24.

The region determining unit 21 may determine a static region and a motion region of the current image based on the encoded information.

The decoding unit 22 may receive a bitstream including the encoded information from the image encoding apparatus 1, obtain the encoded information from the bitstream, and restore the current image exclusive of a FGN based on the encoded information. The FGN generating unit 24 may obtain the information about the FGN coefficient included in the encoded information from the bit stream, and generate a FGN on the basis of the obtained information about the FGN coefficient. For example, the FGN generating unit 24 may determine a FGN of a determined region according to a region determined by the region determining unit 21. The image decoding apparatus 2 may restore the current image by adding the FGN generated by the FGN generating unit 24 to the FGN-removed current image restored by the decoding unit 22.

FIG. 11 is a diagram illustrating encoding and decoding a current image by an image encoding apparatus 1 and an image decoding apparatus 2 according to another exemplary embodiment.

Referring to FIG. 11, the image encoding apparatus 1 includes an encoding unit 12, a FGN removing unit 14, and a FGN coefficient generating unit 15.

In this example, the FGN removing unit 14 may divide a current image into an image exclusive of a FGN and an image including a FGN. The FGN coefficient generating unit 15 may determine a FGN coefficient from the image including the FGN generated by the FGN removing unit 14. For example, the encoding unit 12 may generate encoded information by encoding the image exclusive of the FGN and may transmit the encoded information together with the FGN coefficient determined by the FGN coefficient generating unit 15.

In this example, the image decoding apparatus 2 includes a decoding unit 22 and a FGN generating unit 24. The decoding unit 22 may receive a bitstream from the image encoding apparatus 1 and obtain the encoded information included in the received bitstream. The image decoding apparatus 2 may restore the image exclusive of the FGN based on the obtained encoded information.

The FGN generating unit 24 may generate a FGN on the basis of information about the FGN coefficient included in the encoded information. The FGN generating unit 24 may generate the FGN based on image quality feedback using not only the information about the FGN coefficient but also the encoded information of the decoded previous image.

For example, when an image is decoded at a low bit rate, an image exclusive of the FGN may be restored in the shape of a blurred image. In this example, when a FGN is generated on the basis of the information about the FGN coefficient without image quality feedback, the FGN may appear strongly in the blurred image and thus the restored image may be perceived as unnatural. Thus, the FGN generating unit 24 may generate a more natural FGN using the encoded information of the previous restored image, and restore the current image by adding the generated FGN and the image from which the FGN may be removed by the decoding unit 22.

As described above, according to the one or more of the exemplary embodiments, a new RD cost model is defined in consideration of a FGN so as not to recognize FGN information included in image data as noise and remove the FGN information in the process of encoding an image. Accordingly, an image encoding apparatus may perform encoding according to the new RD cost model. Accordingly, the FGN information may be efficiently compressed without being lost in the encoding process. Thus, the image data may be compressed with high efficiency, and users may experience an image to which the FGN effect is applied.

Also, according to one or more exemplary embodiments, an image encoding apparatus may calculate a FGN error in a motion region of an image in consideration of quantization and encode the image on the basis of the calculated FGN error. Accordingly, the image data may be compressed with high efficiency, the FGN may not be lost in the motion region of the image in a reproduction process. As a result, a user may experience the image to which the FGN effect is applied.

Also, according to one or more exemplary embodiments, the image quality of the frames in the current GOP, which is felt by the users, may be improved while maintaining the conventional image quality distribution structure in the current GOP to be encoded.

As described herein, above terms such as “include” and “have” should be interpreted in default as inclusive or open rather than exclusive or closed unless expressly defined to the contrary.

The exemplary embodiments may be written as a program and may be implemented in a general-purpose digital computer that executes the program by using a computer-readable recording medium. For example, the methods described above can be written as a computer program, a piece of code, an instruction, or some combination thereof, for independently or collectively instructing or configuring a processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

It should be understood that the exemplary embodiments described herein should be considered as a descriptive purpose only and not for purposes of limitation. Also, descriptions of features or aspects within each exemplary embodiment should typically be considered as available for other similar features or aspects in other exemplary embodiments.

While the exemplary embodiments have been described with reference to the figures, it should be understood by those of ordinary skill in the art that various changes in form and details may be made therein without departing from the spirit and scope of the inventive concept as defined by the following claims.

What is claimed is:

1. An image encoding method comprising:
detecting a static region and a motion region of an image;
calculating an encoding error in the image;
calculating a film grain noise (FGN) error in the detected motion region of the image; and
encoding the image to reduce the encoding error in the image other than the calculated FGN error.

2. The image encoding method of claim 1, wherein the detecting the static region and the motion region comprises detecting the motion region using a morphology operation.

3. The image encoding method of claim 1, wherein the detecting the static region and the motion region comprises:
generating an image; and
detecting the motion region in the generated image,
wherein the image is the image excluding a FGN.

4. The image encoding method of claim 1, wherein the calculating the FGN error in the motion region comprises calculating the FGN error in the motion region in consideration of a quantization error.

5. The image encoding method of claim 1, wherein the calculating the FGN error in the motion region comprises calculating a FGN error of a chroma component and a FGN error of a luminance component in the image.

6. The image encoding method of claim 5, wherein the calculating the FGN error of the chroma component and the FGN error of the luminance component in the image comprises calculating the FGN errors of the chroma and luminance components in consideration of a quantization parameter difference between the chroma component and the luminance component.

7. The image encoding method of claim 1, further comprising:
determining an image quality distribution of a plurality of frames that represent an image quality difference caused by different values of a parameter that is used to encode a plurality of frames including the image;
determining an image quality distribution of frames that are to be encoded on the basis of the determined image quality distribution of the plurality of frames; and
determining an encoding parameter of the frames to be encoded based on the image quality distribution of the frames that are to be encoded, and encoding the frames that are to be encoded on the basis of the determined encoding parameter,
wherein a FGN included in the frames that are to be encoded varies according to the determined image quality distribution of the frames to be encoded.

8. An image encoding apparatus comprising:
a region detector configured to detect a static region and a motion region of an image;
an error calculator configured to calculate an encoding error in the image and calculate a film grain noise (FGN) error of the motion region; and
an encoder configured to encode the image to reduce an error in the image other than the calculated FGN error.

9. An image decoding method comprising:
obtaining encoded information from a bitstream;
determining a static region and a motion region of an image included in the bitstream; and
restoring the image using the encoded information related to the determined regions,
wherein the encoded information is generated by encoding the image to reduce an error in the image other than a calculated FGN error included in the motion region.

10. The image decoding method of claim 9, wherein the FGN error in the motion region is calculated in consideration of a quantization error, and the encoded information is generated by encoding the image on the basis of the calculated FGN error.

11. The image decoding method of claim 9, wherein the FGN error in the motion region is calculated in consideration of a FGN error of a chroma component and a FGN error of a luminance component, and the encoded information is generated by encoding the image on the basis of the calculated FGN error.

12. The image decoding method of claim 11, wherein the FGN errors of the chroma and luminance components are calculated in consideration of a quantization parameter difference between the chroma component and the luminance component, and the encoded information is generated by encoding the image on the basis of the calculated FGN error.

13. The image decoding method of claim 9, further comprising restoring frames that are to be encoded on the basis of the encoded information,
wherein an image quality distribution of a plurality of frames that represent an image quality difference caused by different values of a parameter that is used to encode a plurality of frames including the image is determined,
an image quality distribution of the frames that are to be encoded is determined on the basis of the determined image quality distribution of the plurality of frames,
an encoding parameter of the frames that are to be encoded is determined on the basis of the image quality distribution structure of the frames that are to be encoded, the encoded information is generated by encoding the frames that are to be encoded on the basis of the determined encoding parameter, and
a FGN included in the frames that are to be encoded varies according to the determined image quality distribution structure of the frames to be encoded.

14. An image decoding apparatus comprising:
an obtainer configured to obtain encoded information from a bitstream;
a region determiner configured to determine a static region and a motion region of an image; and
a decoder configured to restore the image using the encoded information related to the determined regions,
wherein the encoded information is generated by encoding the image to reduce an error that is calculated in the image other than a calculated FGN error in the motion region.

15. A non-transitory computer-readable medium having recorded thereon a computer program that is executable by a computer to perform the method of claim 1.

16. A non-transitory computer-readable medium having recorded thereon a computer program that is executable by a computer to perform the method of claim 9.
